(19) United States
(12) Patent Application Publication
(10) Pub. No.: US 2007/0229960 A1
(43) Pub. Date: Oct. 4, 2007

(54) Pneumatically Operated, Dimmable Mirror Assembly

(76) Inventors: Niel Mazurek, Huntingdon Valley, PA (US); Theodore J. Zammit, Ambler, PA (US)

Correspondence Address: Cohen, Gary M.;Strafford Building Number Three, 125 Strafford Avenue, Suite 300, Wayne, PA, 19087-3318, US

(21) Appl. No.: 11/597,072

(22) PCT Filed: May 13, 2005
(86) PCT No.: PCT/US05/16970

§ 371 Date: Nov. 20, 2006

Related U.S. Application Data
(60) Provisional application No. 60/573,094, filed on May 21, 2004.

(51) Int. Cl. G02B 5/08

(52) U.S. Cl. 359/604

(57) ABSTRACT

A dimmable mirror assembly operates responsive to changes in the thickness of a light absorbing fluid contained between a transparent glass plate and a high reflectance, first surface mirror. The thickness of the light absorbing fluid layer is pneumatically or hydraulically controlled. Variations in pressure are typically developed responsive to a compressible element which can be controlled manually, or responsive to an electrically operated solenoid or motor, to control pressures for creating desired actuation forces. The actuation forces produced by the resulting assembly can be controlled locally, or can be controlled remotely by the driver. The dimmable mirror assembly is suitable for locations within the interior of a vehicle and outside of the vehicle.

### BACKGROUND OF THE INVENTION

The present invention generally relates to dimmable mirrors, primarily for use with automobiles, trucks and other vehicles.

For some time, there has been a need for an inexpensive and reliable dimmable mirror that can be used with automobiles, trucks and other types of vehicles, to serve not only as the interior, rear-view mirror, but also as the vehicle's outside, rear-view mirror or mirrors. Early attempts included various prismatic constructions. Later attempts used electrochromic technology to replace the earlier prismatic dimmable mirror assemblies. In practice, however, the use of electrochromic technology for outside, dimmable mirror assemblies is not very widespread due to cost and reliability issues.

Other mirror technologies have been attempted over the years. Such technologies, however, have generally not produced a commercially viable product.

For example, one alternate mirror technology which has been proposed involves the placement of a fluid between a clear glass plate and a mirror that acts to attenuate light. The thickness of the fluid layer maintained between the clear glass plate and the light-reflecting mirror is then varied to adjust the amount of light attenuation achieved by the resulting system. This technique has, to date, not provided a commercially viable product primarily because of the mechanical or electromechanical complexity of the mechanism which is used to change the thickness of the fluid layer between the glass plate and the mirror.

For example, U.S. Pat. No. 4,726,656 discloses a relatively complex series of mechanical and electro-mechanical components to change the thickness of the fluid layer between the glass plates which comprise the dimmable mirror assembly. The various embodiments disclosed for this include a bellows unit, shape memory metal coils, mechanical latches and an electrically operated pump to achieve this basic operation.

U.S. Pat. No. 6,164,783 attempts to improve upon the electromechanical system described in U.S. Pat. No. 4,726,656, but continues to employ a relatively complex electro-mechanical system for changing the thickness of the fluid layer between the glass plates which comprise the dimmable mirror assembly. This includes the use of a flat electromagnetic solenoid, leaf springs, bi-directional motors, shape memory alloys, peristaltic pumps and piezoelectric actuators.

In general, such known devices for controlling the operation of a dimmable mirror assembly using an optical fluid either employ various electromechanical devices to move the respective elements of the mirror assembly to affect the dimming function, or to pump the optical fluid in and out of the mirror assembly to affect the dimming function.

It has generally been found that such systems do not result in a practical, commercially viable system for operating such dimmable mirrors, preventing the widespread use of dimmable mirrors based upon the use of an optical fluid.

### SUMMARY OF THE INVENTION

In accordance with the present invention, a dimmable mirror assembly is provided which operates responsive to changes in the thickness of a light absorbing fluid contained between a transparent glass plate and a high reflectance, first surface mirror. The thickness of the light absorbing fluid layer is pneumatically or hydraulically controlled. To this end, variations in pressure are typically developed responsive to a compressible element which can be controlled manually, or responsive to an electrically operated solenoid, motor or pump, as desired, to control the pressures that are to create the desired actuation forces. The actuation forces produced by the resulting assembly can be controlled locally, to produce a dimmable mirror suitable for location within the interior of a vehicle, or can be controlled remotely by the driver to produce a dimmable mirror which is suitable for location outside of the vehicle.

For further discussion of the dimmable mirror of the present invention, reference is made to the detailed description which is provided below, taken together with the following illustrations.

### BRIEF DESCRIPTION OF THE DRAWINGS

FIG. 1 is an isometric view illustrating the overall components of the dimmable mirror of the present invention.

FIG. 2 is a cross-sectional view illustrating the mirror assembly of FIG. 1 in the non-activated mode.

FIG. 3 is a cross-sectional view illustrating the mirror assembly of FIG. 1 in the activated mode.

FIG. 4 is a plan view illustrating placement of the flexible tubing within the mirror assembly.

FIG. 5A is a partial, cross-sectional view illustrating a first alternative embodiment for the placement of flexible tubing within the mirror assembly shown in FIG. 4, in the non-activated position.

FIG. 5B is a partial, cross-sectional view illustrating the first alternative embodiment for placement of the flexible tubing within the mirror assembly, as shown in FIG. 5A, in the activated position.

FIG. 6A is a partial, cross-sectional view illustrating a second alternative embodiment for the placement of flexible tubing within the mirror assembly shown in FIG. 4, in the non-activated position.

FIG. 6B is a partial, cross-sectional view illustrating the second alternative embodiment for placement of the flexible tubing within the mirror assembly, as shown in FIG. 6A, in the activated position.

FIG. 7A is a partial, cross-sectional view illustrating an alternative embodiment for the integration of a spring into the front housing of the mirror assembly, in the non-activated position.

FIG. 7B is a partial, cross-sectional view illustrating the alternative embodiment for the integration of a spring into the front housing of the mirror assembly, as shown in FIG. 7A, in the activated position.

FIG. 8 is a partially sectioned view illustrating a first alternative embodiment of a direct manual control for operating the mirror assembly of FIG. 1, in the non-activated position.

FIG. 8A is a plan view illustrating the position of the cam shown in FIG. 8.

FIG. 9 is a partially sectioned view illustrating the first alternative embodiment of the direct manual control for operating the mirror assembly shown in FIG. 8, in the activated position.

FIG. 9A is a plan view illustrating the position of the cam shown in FIG. 9.

FIG. 10 is a partially sectioned view illustrating a second alternative embodiment of a direct manual control for operating the mirror assembly of FIG. 1, in the non-activated position.

FIG. 10A is a plan view illustrating the position of the cam shown in FIG. 10.

FIG. 11 is a partially sectioned view illustrating the second alternative embodiment of the direct manual control for operating the mirror assembly shown in FIG. 10, in the activated position.

FIG. 11A is a plan view illustrating the position of the cam shown in FIG. 11.

FIG. 12 is a partially sectioned view illustrating an alternative embodiment of an electronic control system for operating the mirror assembly of FIG. 1, in the non-activated position.

FIG. 13 is a partially sectioned view illustrating the alternative embodiment of the electronic control system for operating the mirror assembly shown in FIG. 12, in the activated position.

FIGS. 14A and 14B are partially sectioned views illustrating further alternative embodiments of an electronic control system for operating the mirror assembly of FIG. 1.

### DETAILED DESCRIPTION OF THE INVENTION

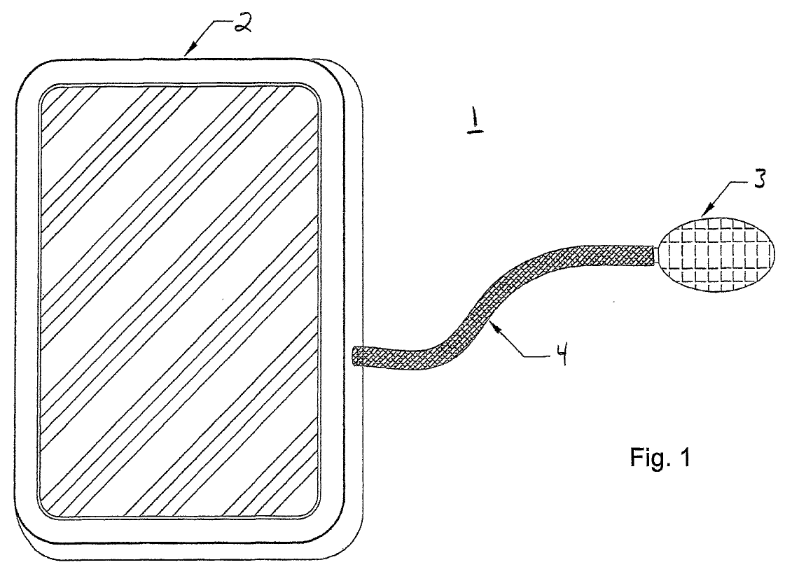

FIG. 1 illustrates an embodiment of a dimmable mirror assembly 1 which has been produced in accordance with the present invention. The dimmable mirror assembly 1 is generally comprised of an assembly of components including a mirror assembly 2, a pneumatic pressure-producing device 3, and a pressure tube 4 connecting the mirror assembly 2 and the pneumatic device 3.

As will be described more fully below, the dimmable mirror assembly of the present invention uses a pressure source to expand flexible tubing located in the mirror assembly, for altering the thickness of a fluid layer which is established between a transparent plate and a mirror associated with the mirror assembly. The need to locate electro-mechanical devices within the mirror assembly, and the need to manipulate optical fluids with electric pumps and valves, can in this way be eliminated.

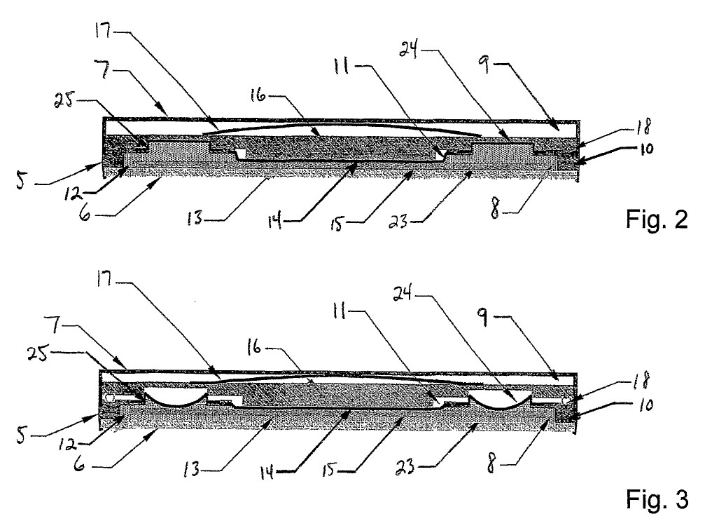

Referring also to FIGS. 2 and 3, the exterior of the mirror assembly 2 is generally comprised of a housing section 5 which is enclosed by a face plate 6, and a housing section 7 which is attached to the housing section 5.

The housing sections 5, 7 are preferably made from moldable plastic materials, such as ABS plastics, although other resilient materials, such as stamped sheet metals, could also be used, if desired. The face plate 6 is preferably transparent, and can be made from plate glass, clear acrylic or polycarbonate plastics, or other materials having similar properties.

The face plate 6 is attached to the front of the housing section 5, preferably using an adhesive which is appropriate for joining dissimilar materials such as the glass and plastic materials which are used in the manufacture of such components. A secondary, silicone-based adhesive, available from companies such as Dow Corning or GE, is preferably used in addition to the primary adhesive to ensure that the resulting cavity 8 is effectively sealed. The housing section 7 is attached, and preferably sealed to the housing section 5 using an adhesive which is appropriate for protecting the resulting cavity 9 from contaminants.

The housing section 5 includes a frame 10 which forms the periphery of the housing section 5, and a flexible seal 11 which is coupled with the frame 10. The face plate 6 is sealed to the frame 10 of the housing section 5 and, coupled with the flexible seal 11, forms a sealed cavity 8 for receiving a light absorbing optical fluid 12. The flexible seal 11 is preferably constructed as a rubber insert joined to the frame 10 of the housing section 5.

A mirrored plate 13 is attached to central portions 14 of the flexible seal 11, and includes a mirrored surface 15 which is positioned adjacent to the face plate 6. As an alternative, the mirrored plate 13 can be attached to plural positions on the flexible seal 11, if desired, to provide spaced supports for the mirrored plate 13. The mirrored plate 13 can be made from plate glass, an acrylic or polycarbonate plastic, a metal, or an equivalent material, which is preferably silver coated to form a reflective surface. The mirrored plate 13 and the flexible seal 11 are preferably attached using an adhesive which is appropriate for joining rubber to a glass or plastic material. A similar adhesive can be used to attach the flexible seal 11 to the frame 10 of the housing section 5. Suitable adhesives for accomplishing this are available from companies such as MasterBond, Epoxy Technologies, and others.

A backing plate 16 is also attached to the central portions 14 of the flexible seal 11, as shown in FIGS. 2 and 3, or to plural positions on the flexible seal 11, if desired, on a side of the flexible seal 11 which is opposite to the side which receives the mirrored plate 13, and is slidingly received within the cavity 9. A leaf spring 17 is positioned between the backing plate 16 and the housing section 7 to bias the backing plate 16, and the mirrored plate 13 coupled with the backing plate 16, toward the face plate 6. The light absorbing optical fluid 12 fills the remainder of the cavity 8, surrounding the mirrored plate 13, as shown. The backing plate 16 is preferably made from a moldable plastic material, such as an ABS plastic, although other resilient materials, such as stamped sheet metals, could also be used, if desired. The backing plate 16 is preferably attached to the flexible seal 11 using an adhesive which is appropriate for joining rubber to a glass or metal material.

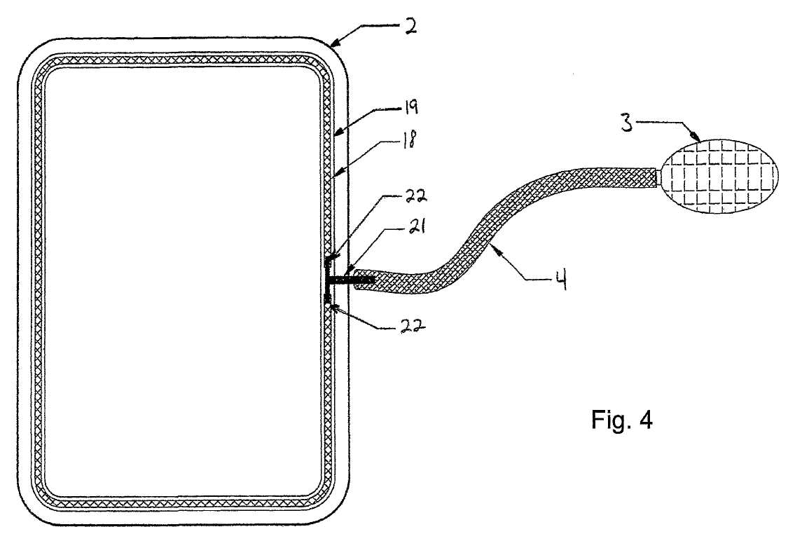

Additionally referring to FIG. 4, flexible tubing 18 is shown located in a channel 19 formed between the housing section 5 and the backing plate 16. Use of the channel 19 is preferred for situations where containment of the flexible tubing 18 is considered desirable. A series of guides can also be used to receive the flexible tubing 18 in situations where containment of the flexible tubing 18 is not required. It is also possible to position the flexible tubing 18 about the periphery of the mirror assembly 2, without providing any retention structures, so that the flexible tubing 18 is frictionally retained in desired position. In any event, the flexible tubing 18 is connected to the pneumatic device 3 via the pressure tube 4, as previously described.

In accordance with the present invention, the flexible tubing 18 is used to provide direct separation forces for causing the mirror assembly 2 to dim responsive to separation between the face plate 6 and the mirrored plate 13, as will be described more fully below. To this end, the flexible tubing 18 can be made of any of a variety of materials, including natural rubber latex, a thermoplastic elastomer or polyvinyl chloride. The thickness of the walls forming the flexible tubing 18 is preferably selected to minimize the amount of force required to distort the flexible tubing 18 from its natural (for example, circular) shape to the shape of the channel 19 which is developed between the frame 10 of the housing section 5 and the backing plate 16.

As an example, typical latex tubing useful for a mirror assembly 2 having a 50 square inch mirror area has a diameter of 5/32 in. and a wall thickness of 3/64 in. Such tubing develops a contact area between the frame 10 of the housing section 5 and the backing plate 16 of approximately 0.1 inch in width and 40 inches in length, yielding a contact area on the order of 4 square inches. Upon the application of a pressure of 4 PSI to the flexible tubing 18, a force of approximately 16 lbs. is exerted for separating the frame 10 of the housing section 5 and the backing plate 16, which is sufficient for typical operations of the dimmable mirror assembly 1 as will be described more fully below.

The size of the flexible tubing 18 which is selected for use, and the channel 19 which receives the flexible tubing 18, are preferably selected to provide the maximum separation force for the minimum amount of pressure applied to the system. As a secondary consideration, the flexible tubing 18 and the channel 19 are preferably selected to create a desired maximum separation of the plates 6, 13 when the maximum pressure is applied to the system.

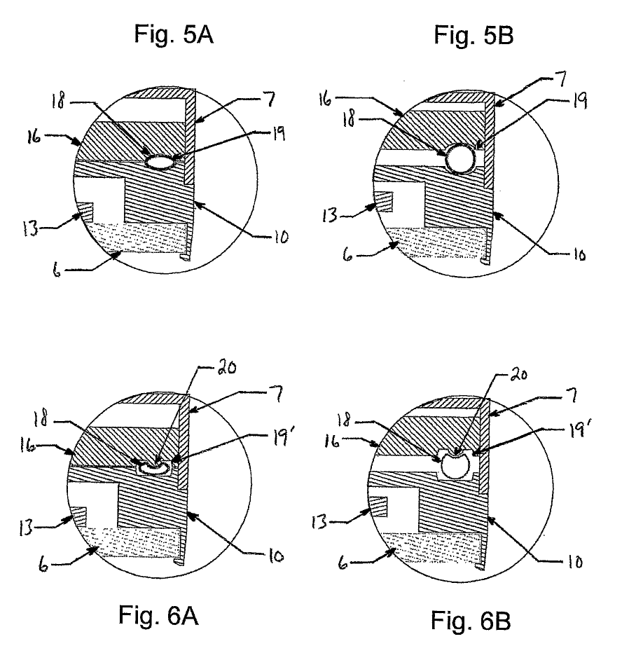

FIGS. 5A and 5B illustrate a first example of flexible tubing 18 received within a channel 19 for achieving appropriate movement of the backing plate 16 relative to the frame 10 of the housing section 5, as previously described. FIG. 5A illustrates a generally oval-shaped cavity 19 for receiving the flexible tubing 18 when in an uninflated state (backing plate 16 adjacent to the frame 10). In FIG. 5B, the flexible tubing 18 is inflated, assuming a generally circular shape and providing a desired maximum separation of the backing plate 16 and the frame 10 of the housing section 5.

FIGS. 6A and 6B illustrate a second example in which the flexible tubing 18 is received within a notched channel 19′ for achieving movement of the backing plate 16 relative to the frame 10 of the housing section 5. For this embodiment, FIG. 6A illustrates a generally U-shaped cavity 19′ for receiving the flexible tubing 18 when in an uninflated state (backing plate 16 adjacent to the frame 10). In FIG. 6B, the flexible tubing 18 is again shown inflated, assuming a generally circular shape and providing the desired maximum separation for the backing plate 16 and the frame 10 of the housing section 5. A notched projection 20 associated with the U-shaped channel 19′ operates to compress the adjacent portions of the flexible tubing 18, increasing the amount of travel which can be achieved responsive to inflation of the flexible tubing 18.

Flexible tubing and tube-receiving channels having other shapes and sizes can also be used to achieve the foregoing operations. For example, square tubing, bellows tubing, and D-shaped tubing, among others, can be used together with any of a variety of suitable cavity configurations.

In the embodiment illustrated in FIG. 4, the channel 19 and the flexible tubing 18 received within the channel 19 run fully around the perimeter of the mirror assembly 2. A T-fitting 21 connects opposing ends 22 of the flexible tubing 18 to each other, and to the pressure tube 4. This configuration provides uniform separating forces between the backing plate 16 and the frame 10 of the housing section 5, and for this reason, is presently considered preferred.

Other placements for the flexible tubing are also possible. For example, two separate sections of tubing can be placed along opposing horizontal edges of the mirror assembly 2, or along opposing vertical edges of the mirror assembly 2. As an alternative, four separate sections of tubing can be placed along the horizontal and vertical edges of the mirror assembly 2. As a further alternative, plural, discrete sections of flexible tubing can be positioned along the perimeter of the mirror assembly 2.

Different media can be used for conveying pressure to the flexible tubing 18 associated with the mirror assembly 2. Air can be used as the pressure-conveying medium, which can simplify installation of the flexible tubing and the connecting structures in a vehicle. Fluids can, in the alternative, be used as the pressure-conveying medium. Fluids are not compressible, and will tend to produce changes in volume which will be less significant over the anticipated range of operating temperatures to be encountered. Although the use of fluids provides a more efficient method of transferring pressure to the mirror assembly 2, the use of fluids can complicate installations in vehicles.

Selection of the pressure-conveying medium is related to the configuration of the mirror assembly 2 and the device 3 which is used to control the operation of the dimmable mirror assembly 1. For installations where the mirror assembly 2 and pressure-producing device 3 are in close proximity, a fluid medium (for example, a typical hydraulic fluid such as automotive transmission fluid) can appropriately be used. For installations where the mirror assembly 2 and pressure-producing device 3 are in separate areas, requiring the supply of pressure through one or more conduits, air can appropriately be used as the operating medium. In either case, the dimming controls for the dimmable mirror assembly are preferably optimized for the pressure medium which is selected for use.

In operation, a non-activated mode is assumed when the inner surface 23 of the face plate 6 is in close proximity to the surface 15 of the mirrored plate 13, as shown in FIG. 2. This creates a thin layer of the light absorbing optical fluid 12, permitting a minimum amount of light to be absorbed and causing the dimmable mirror assembly 1 to operate in a high reflectance mode (for example, a reflectance of greater than 80%). In this mode, the surface 23 of the face plate 6 and the surface 15 of the mirrored plate 13 are maintained in close proximity by the force of the spring 17. The force of the spring 17 is sufficient to force all but a thin layer of the light absorbing optical fluid 12 from between the face plate 6 and the mirrored plate 13. Also in this mode, the flexible tubing 18 is collapsed between the frame 10 of the housing section 5 and the backing plate 16 by the force of the spring 17. In the non-activated mode, the pneumatic device 3 creates no pressure in the flexible tubing 18.

An activated mode is assumed by applying pressure to the mirror assembly 2 using the pneumatic device 3, as will be described more fully below, to in turn apply pressure to the flexible tubing 18 (via the pressure tube 4). This pressure causes the flexible tubing 18 to inflate, causing the flexible tubing 18 to assume a circular or near circular cross-section, as shown in FIG. 3. In response, the backing plate 16 is caused to separate from the frame 10 of the housing section 5. As these structures separate, the flexible seal 11 and the mirrored plate 13 attached to the central portions 14 of the backing plate 16 are caused to move away from the face plate 6. As the mirrored plate 13 and the face plate 6 separate, light absorbing optical fluid 12 is drawn into the space created between the inner surface 23 of the face plate 6 and the surface 15 of the mirrored plate 13.

The distance separating the face plate 6 and the mirrored plate 13 will vary responsive to the pressure applied to the flexible tubing 18 and the return force of the spring 17. As increased pressures are applied, a greater separation will be developed between the face plate 6 and the mirrored plate 13, causing a greater amount of the light absorbing optical fluid 12 to be drawn into the space which is then created between the face plate 6 and the mirrored plate 13. The resulting increase in the thickness of the light absorbing fluid layer 12 will reduce the reflectance of the mirrored plate 13 proportionately. The characteristics of the light absorbing optical fluid 12 are selected so that, at a maximum separation between the face plate 6 and the mirrored plate 13, a nominal reflectance of 15% is achieved. In this way, the reflectance of the dimmable mirror assembly 1 can be controlled continuously between the maximum reflectance of the non-activated mode and the minimum reflectance of the activated mode.

As an alterative, the dye concentration in the optical fluid 12, which establishes the light absorbing characteristics of the optical fluid 12 as will be described more fully below, can be adjusted to attenuate light so the mirrored plate 13 cannot be seen by an observer. As a result, the face plate 6, having an inherently low reflectance of approximately 4%, will act as a low reflectance mirror.

Releasing the pressure applied by the pneumatic device 3 will return the mirror assembly 2 to the high reflectance state responsive to the force of the return spring 17. This provides the fail-safe mode which is required by federal regulations for dimmable mirror devices used on automotive vehicles.

The initial force required to separate the face plate 6 and the mirrored plate 13 is a function of elements including the contact area of the plates, the initial gap between the plates, the viscosity of the optical fluid and the return spring force. Separation of the face plate 6 and the mirrored plate 13 would tend to create a vacuum in the gap developed between the two plates. Instead of a vacuum being created, optical fluid is drawn into the resulting gap. Initially, the gap between the plates is small and the flow of optical fluid into the gap is restricted. This results in a force which acts against the separation of the plates. As the gap between the plates increases, the restriction to the flow of optical fluid decreases rapidly. The larger the initial gap between the plates, the less initial force is required to separate the plates. The larger the area of the plates, the larger the initial force which is required to separate the plates.

The viscosity of the optical fluid 12 determines the initial force required to separate the plates 6, 13. The higher the viscosity of the optical fluid, the larger the force required to separate the plates (to achieve the dimmed mirror state). The force applied to separate the plates 6, 13 must also overcome the return force of the spring 17.

As an example, for a typical application in conjunction with an automotive mirror, the areas for the face plate 6 and the mirrored plate 13 will typically range from about 25 sq. inches to 100 sq. inches. Assuming an initial gap between the face plate 6 and the mirrored plate 13 of 0.001 to 0.005 inches, a viscosity for the optical fluid of less than 500 centistokes, and a return force for the spring 17 of 2 lbs. to 5 lbs., a typical force applied to separate plates having a mirror area on the order of 50 sq. inches will range between 10 lbs. to 20 lbs.

As mentioned previously, the force of the spring 17 should be sufficient to force all but a thin layer of the light absorbing optical fluid 12 from between the face plate 6 and the mirrored plate 13. This can be accomplished by placing a single leaf spring, such as the leaf spring 17 shown in FIGS. 2 and 3, or multiple leaf springs, if desired, between the backing plate 16 and the outer housing section 7. Such leaf springs are typically made of spring steel. For a mirrored plate 13 having a surface area on the order of 50 square inches, four steel leaf springs having a size of approximately 4.0 in.×0.5 in.×0.032 in. would typically be used. Each spring would then generate a return force of approximately 0.5 lbs., yielding a total return force of approximately 4.0 lbs. The use of multiple springs is preferred to provide a more uniform application of these return forces across the surface of the backing plate 16.

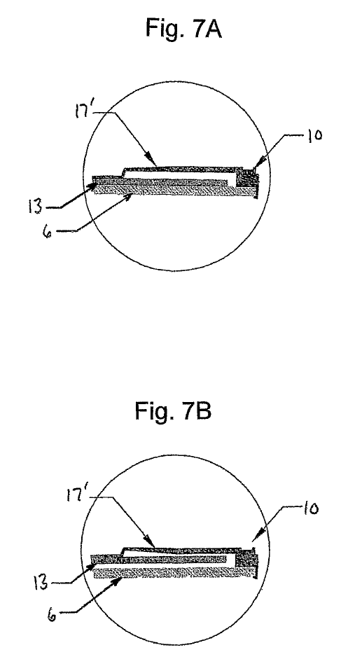

As an alternative to use of the leaf springs 17 shown in FIGS. 2 and 3, a spring 17′ can be integrated into the frame 10 of the housing section 5, as is shown in FIGS. 7A and 7B. FIG. 7A illustrates the resulting assembly in a non-activated position. FIG. 7B illustrates the resulting assembly in an activated position. Employing the spring 17′ shown in FIGS. 7A and 7B reduces the overall thickness of the resulting assembly, but increases the complexity of the design of the housing section 5.

As a further alternative to use of the leaf springs 17 shown in FIGS. 2 and 3, flexible tubing can be used to perform the function of a return spring. For example, flexible tubing similar to the flexible tubing 18 which is used to separate the mirrored plate 13 from the face plate 6 can similarly be used to compress the plates 6, 13 together. Such flexible tubing can be made of silicone, or a latex material, and can typically have a diameter in a range of from 0.250 to 0.350 inches and a wall thickness in a range of from 0.015 to 0.032 inches. The diameter and wall thickness of such flexible tubing determines the return spring force as the flexible tubing is crushed. By selecting flexible tubing with a crush force greater than the flexible tubing 18 used to separate the plates 6, 13, and by placing the flexible tubing between the backing plate 16 and the housing section 7, the spring force is sufficient to force all but a very thin layer of the optical fluid 12 out from between the face plate 6 and the surface 15 of the mirrored plate 13.

Another alternative to use of the leaf springs 17 shown in FIGS. 2 and 3 is the use of spring washers, such as “Clover Dome” spring washers, which are available from Clover Springs Customized Spring Washers of Troy, Mich. Such spring washers can be designed to develop a spring force in an active area which is in a range of from 2 to 5 lbs. Spring washers are capable of providing a constant spring force over the operating movement range of the backing plate 16. The use of a constant force return spring has the advantage of reducing the pressure required to inflate the flexible tubing 18 that separates the plates 6, 13, to achieve maximum separation of the plates 6, 13, and for this reason, is presently considered preferred.

The spacing between the face plate 6 and the mirrored plate 13, while maintained in close proximity to one another by the force of spring 17, 17′, is preferably controlled by placing a spacer between the plates 6, 13. Such a spacer is preferably implemented as a pattern of small dots formed on the inner surface 23 of the face plate 6 or on the surface 15 of the mirrored plate 13, for example, by screen printing. As an example, such a spacer can be developed using dots formed of a polyamide, having a thickness of from 0.001 in. to 0.005 in. and a diameter of from 0.005 in. to 0.01 in. The pattern selected for the dots is preferably biased to place the dots in areas at the periphery of the plates 6, 13 to increase the flow of optical fluid 12 into the gap which is developed between the plates 6, 13 as initial forces are applied to separate the plates.

The actuation of a dimmable mirror assembly cannot cause voids (for example, air pockets) to form between the face plate 6 and the mirrored plate 13 because this would then create non-uniformities in the reflectance observed by the driver. For this reason, as the face plate 6 and the mirrored plate 13 separate, only the optical fluid 12 must be drawn into the gap between the plates 6, 13, and not air. This is achieved by ensuring that the amount of the optical fluid 12 which is maintained in the sealed cavity 8 is more than sufficient to fill the maximum gap which can be developed between the face plate 6 and the mirrored plate 13. Further, the sealed cavity 8 must only be filled with the optical fluid 12, and cannot contain any air pockets. In addition, the sealed cavity 8 must maintain a constant volume during actuation of the mirror assembly 2, based upon the initial volume of the optical fluid 12.

Rearward movement of the backing plate 16, during dimming, would ordinarily act to increase the volume of the sealed cavity 8. The optical fluid 12 will maintain a constant volume. As a result, rearward movement of the mirrored plate 13 coupled with the backing plate 16 would act to increase the volume of the sealed cavity 8. Because the optical fluid 12 maintains a constant volume, a vacuum would then tend to be created. The forces required to create such a vacuum would typically act to prevent rearward movement of the mirrored plate 13.

Referring to FIGS. 2 and 3, this is overcome by providing the housing section 5 with flexible panels 24 which cooperate with apertures 25 formed in the housing section 5. As the backing plate 16 and the associated mirrored plate 13 are retracted, during activation of the mirror assembly 2, the flexible panels 24 allow the volume of the sealed cavity 8 to remain constant without exerting undo force on the rearward movement of the backing plate 16 and the mirrored plate 13.

As an example, the flexible panels 24 can be formed as rubber inserts located in the apertures 25 and coupled with the housing section 5. Care must be taken to ensure that no leaks occur in the seals which are established between the face plate 6, the flexible seal 11, and the flexible panels 24, and the portions of the housing section 5 to which such structures are attached.

FIG. 2 illustrates a cross-section of the mirror assembly 2, showing the flexible panels 24 associated with the housing section 5 in a position which would normally be assumed during a non-activated mode. In this configuration, the flexible panels 24 are in a passive, initially formed state. FIG. 3 illustrates a cross-section of the mirror assembly 2, showing the flexible panels 24 when the mirror assembly 2 is in an activated mode. In this configuration, the flexible panels 24 are drawn into the cavity 8 to compensate for changes in the volume of the cavity as the mirror assembly is activated. The volume of the optical fluid 12 maintained in the cavity 8 remains the same in both the activated and non-activated modes.

Selection of the optical fluid 12 is critical to the proper operation of the dimmable mirror assembly 1. The optical fluid 12 is typically a transparent host fluid incorporating a light absorbing dye dissolved into the host fluid.

Properties affecting the performance of the host fluid include the optical properties, the stability, the viscosity and the toxicity of the selected fluid, and the solubility of the dye in the host fluid.

The optical property of greatest importance is the index of refraction of the host fluid. The index of refraction of the host fluid, when combined with the dye, must closely match the index of refraction of the face plate 6. This is required to substantially reduce the reflection of light at the interface of the face plate 6 and the optical fluid 12. The reflection of light from this interface creates an observable secondary image when the mirrored plate 13 is positioned in the activated mode (plates 6, 13 separated). Such a secondary image will appear as a “ghost” image of the primary image produced from the mirrored plate 13. The severity of such ghosting is a function of the mismatch between the index of refraction of the host fluid and the index of refraction of the face plate 6.

Another optical property to consider is that the host fluid should have very minimal light scattering across the visible wavelengths. Light scattering by the optical fluid 12 will reduce the sharpness and contrast of the reflected image. It is also desirable that the optical fluid 12 have very minimal light attenuation in the visible spectrum. The light absorption of the optical fluid 12 will then only be a function of the dissolved dye.

The host fluid must also be stable over time. Exposure of the dimmable mirror assembly 1 to environmental conditions outside the vehicle with which it is used should not degrade the host fluid, including changes in fluid color or viscosity. This would include stability to ultraviolet exposure and extreme temperature ranges.

The viscosity of the host fluid is important to the operation of the dimmable mirror assembly 1 when activated. As previously described, the viscosity of the host fluid directly impacts upon the initial force required to separate the face plate 6 and the mirrored plate 13. The viscosity of the host fluid must be such that, over the intended operating temperature range, the force created by the pressure applied to the flexible tubing 18 is always sufficient to separate the plates 6, 13.

The host fluid must not be toxic. In the event the mirror assembly 2 is damaged, the optical fluid 12 could leak out. Human contact with the optical fluid 12 could then occur. This would be especially important for mirror application inside a vehicle.

The host fluid must allow a sufficient amount of a dye to be dissolved in the host fluid to provide sufficient light absorption to meet the low reflectance required when the plates 6, 13 are separated by a maximum gap. The dye must remain in solution over the operating temperature range for the mirror assembly, and should provide a useful product life.

The host fluid must also be compatible with the materials used to fabricate the dimmable mirror assembly 1. Specifically, the face plate 6, the mirrored plate 13, the flexible seal 11, the flexible panels 24, the housing section 5 and the adhesives used for assembly must all be compatible with one another.

A preferred host fluid that best meets the foregoing considerations is silicone oil, such as siloxane, which is often used as an optical fluid in laser optical technology. It is desirable for the silicone oil to have the capability of being formulated to match specific indices of refraction. For example, silicone oil with an index of refraction of 1.5 is specified when used with a transparent (colorless) glass plate, and an index of refraction of 1.6 is specified when used with a polycarbonate plate.

Silicone oils used in optical applications provide no measurable light attenuation or scattering over the range of visible wavelengths for the plate gap distances typically present in the dimmable mirror assembly 1. In addition, silicone oils have a transmissivity greater than 99% for the typical plate gap distances which are used. In addition, silicone oils used in optical applications have been shown to be stable over a ten year period of time. No yellowing or change in optical properties should be observed over this period of time. Silicone oils can be formulated to provide low viscosities consistent with the operating temperature range of the dimmable mirror assembly 1. For example, silicone oil specified for the dimmable mirror assembly 1 would have a viscosity less than 500 centistokes over the specified operating temperature range. Silicone oils are further compatible with the materials used in the dimmable mirror assembly.

Other optical fluids can be used in the dimmable mirror assembly 1, one such example being phthalate esters. While such optical fluids have appropriate optical properties, and a low viscosity, such fluids would require alternate materials to be used in the fabrication of the mirror assembly 2 to maintain compatibility.

Properties affecting the performance of the dye which is dissolved in the host fluid include the optical properties, the stability and the toxicity of the selected dye, and the solubility of the dye in the host fluid.

The optical property of greatest importance is that the dye perform as a neutral density filter (i.e., exhibiting equal light absorption across the visible spectrum). This minimizes any color shift in the reflected image.

The rate of color degradation of the dye, when subjected to ultraviolet exposure, must be sufficiently low to maintain an acceptable dimmed image over the useful life of the assembly. Ultraviolet exposure of the dye in the mirror assembly 2 is minimal. During daytime operation, the mirror assembly 2 is typically in the non-activated state. When in this mode, the majority of the optical fluid 12 containing the dye will not be exposed directly to sunlight. Activation of the mirror assembly 2 will typically occur from dusk to dawn, with a minimal amount of exposure to the sun (for example, when the mirror assembly is used to dim the sun, when low on the horizon behind the vehicle). Further mitigating degradation of the dye because of ultraviolet exposure is that only a small portion of the optical fluid 12 is exposed during activation, and any such exposed portions are then remixed with remaining optical fluid 12 in the cavity 8 when the mirror assembly 2 is returned to a non-activated state. The dye must also be soluble in the host fluid at a concentration that meets the necessary optical and environmental requirements. The addition of the dye to the host fluid must not make the resulting optical fluid toxic.

An example of a dye which is capable of meeting the above considerations is aniline dyes that are formulated to be soluble in oil. An optical fluid created by combining silicone oil and aniline dye exhibits the optical properties required for proper operation of the dimmable mirror assembly 1.

For plates 6, 13 formed of glass, the typical gap between the plates 6, 13, when in the fully activated mode is 0.040 inches. To achieve a reflectance of approximately 15%, the optical fluid 12 must attenuate the light by 60%. Aniline dye having a concentration of 0.25% (by volume) added to silicone oil provides a light absorption rate of approximately 1.5% per 0.001 inches of fluid thickness, achieving the required attenuation of 60%. This is well below the solubility limits of aniline dye in silicone oil for the proposed operating temperature range of the dimmable mirror assembly 1.

Other dyes can also be used to produce a satisfactory optical fluid for use in the dimmable mirror assembly 1. This would include azo dyes and anthraquinone dyes, for example.

The reflection of light from the outer surface of the face plate 6 can create a tertiary image if there is a mismatch of the index of refraction of the face plate 6 relative to the index of refraction of air. The tertiary image has a reflectance value of approximately 4% when the face plate 6 is made from glass. During daytime operation, the intensity of the resulting ghost image compared with the image reflected by the mirrored plate 13 does not tend to be distracting to the driver. When the mirror assembly 2 is fully activated, the tertiary image can be more apparent when compared to a reflectance of approximately 15% for a mirrored plate 13 formed of glass. This ghost image can be considered a distraction to some vehicle drivers.

An anti-reflective coating is preferably applied to the outer surface of the face plate 6, to significantly reduce the intensity of the tertiary (ghost) image. Suitable antireflective coatings can include multiple layers of silicon dioxide and titanium dioxide, and a single layer of MgF₂.

As previously indicated, the mirror assembly 2 is operated to provide a dimming function by controlling the pressure which is applied to the flexible tubing 18. This, in turn, inflates the flexible tubing 18, from a compressed condition to its rounded shape, to cause separation of the mirrored plate 13 from the face plate 6 (for example, both formed of glass). This is accomplished using the pneumatic device 3, via the connecting tube 4.

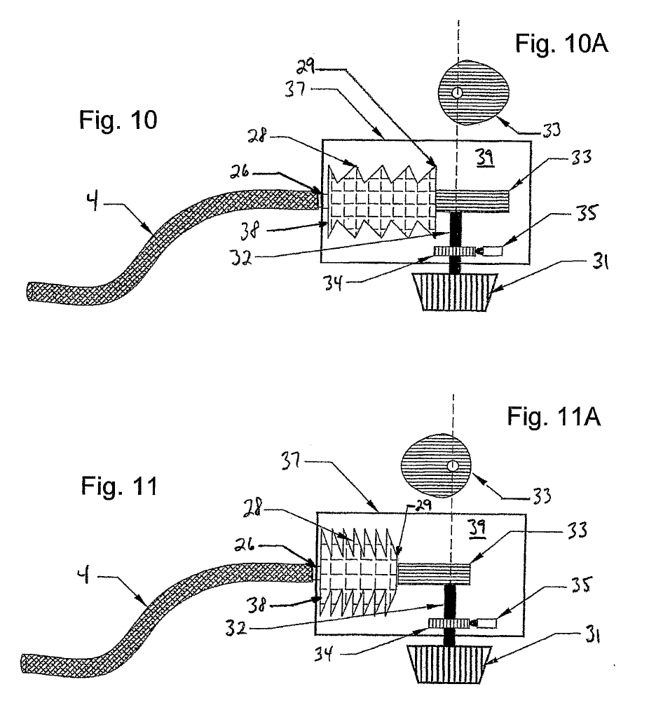

The pressure-producing device 3 can take any of a variety of forms. Two preferred forms of the device 3 for use with the previously described mirror assembly 2 employ a bulb or a closed end bellows. As is shown in FIG. 1, a bulb can be used as the device 3, and is typically an oval shaped, hollow flexible rubber or plastic bladder having an opening 26 at one of its ends. By squeezing the bulb, air is forced out of the bulb, through the opening 26, and into the connecting tube 4. A closed ended bellows (shown, for example, in FIGS. 10 and 11) can also be used as the device 3, and is typically a flexible rubber or plastic unit 27 having folds 28 that allow the overall length of the device to vary. One end 29 of the bellows is closed and the opposite end of the bellows again includes the opening 26 for communicating with the connecting tube 4. Decreasing the length of the bellows, by compressing the end 29, forces air out of the bellows and through the opening 26, achieving the desired effect.

Control of the dimming function is preferably achieved using one of two basic methods including direct manual control and electronic control.

A control mechanism for achieving direct manual control preferably allows the operator to make desired adjustments by taking simple actions such as the turning of a knob, the flipping of a lever, or other equivalent function that directly causes air to be forced from the pressure-producing device 3 to inflate the flexible tubing 18 in the mirror assembly 2. Such direct manual control allows the function of the mirror assembly to be remotely controlled, for example, from inside the vehicle (to control an outside mirror), without the need to derive any power from the vehicle.

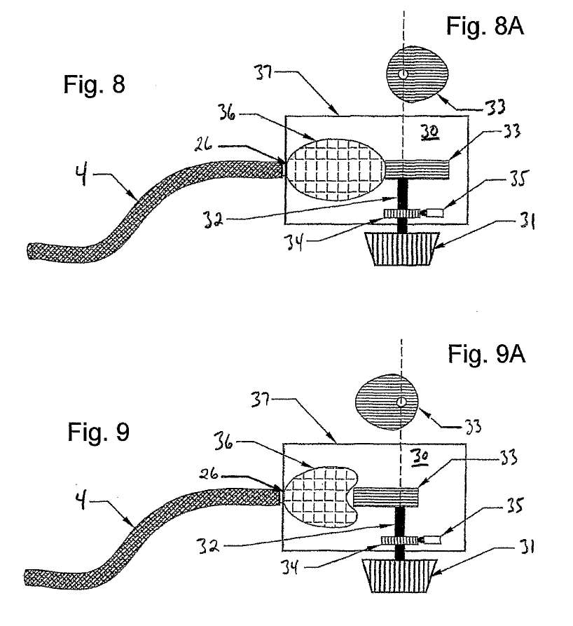

One such embodiment, for direct manual control of the mirror assembly 2 using a bulb as the pressure device, is shown in FIGS. 8 and 9. FIG. 8 illustrates the control device 30 in a non-activated position. FIG. 9 illustrates the control device 30 in the activated position.

The control device 30 includes a knob 31, and a shaft 32 which is mated with the knob 31 and which terminates in a cam 33. A notched wheel 34 is further coupled with the shaft 32, and cooperates with a detent device 35 to maintain the position selected for the cam 33 responsive to rotations of the knob 31. A pressure bulb 36, similar to the pressure-producing device 3 shown in FIG. 1, is coupled with the cam 33. The entire assembly is contained in a housing 37 for mounting the various components of the control device 30. The pressure bulb 36 is connected with the connecting tube 4, to communicate with the mirror assembly 2 as previously described.

The knob 31 is connected to the shaft 32 such that rotation of the knob 31 also causes the shaft 32 to rotate. The cam 33 is connected to the shaft 32 such that rotation of the shaft 32 also causes rotation of the cam 33. Rotation of the cam 33 from the non-activated position shown in FIG. 8 (see also, FIG. 8A) to the activated position shown in FIG. 9 (see also, FIG. 9A) compresses the bulb 36, producing a pressure capable of inflating the flexible tubing 18 in the mirror assembly 2 via the tube 4 connected to the mirror assembly 2. The notched wheel 34 associated with the shaft 32 cooperates with a detent device 35 to hold the shaft 32, and the cam 33 associated with the shaft 32, at discrete angular positions as the knob 31 is rotated. This allows the user to set the control device 30 to select between multiple, discrete dimming levels.

Another embodiment for direct manual control of the mirror assembly 2, which replaces the bulb 36 of the control device 30 shown in FIGS. 8 and 9 with a bellows 38, is shown in FIGS. 10 and 11. FIG. 10 (see also, FIG. 10A) illustrates this control device 39 in a non-activated position. FIG. 11 (see also, FIG. 11A) illustrates this control device 39 in the activated position. The overall configuration and operation of the control device 39 shown in FIGS. 10 and 11 is otherwise the same as that of the control device 30 shown in FIGS. 8 and 9, except for use of the bellows 38 to produce the pressure which is used to inflate the flexible tubing 18 in the mirror assembly 2, again via the tube 4 connected to the mirror assembly 2.

In some applications, it is desirable to electronically control the previously described dimming functions. For example, if dimming of the mirror is to be automated, using light sensors to determine when dimming is to occur, electronic control of the dimmable mirror assembly 1 is required.

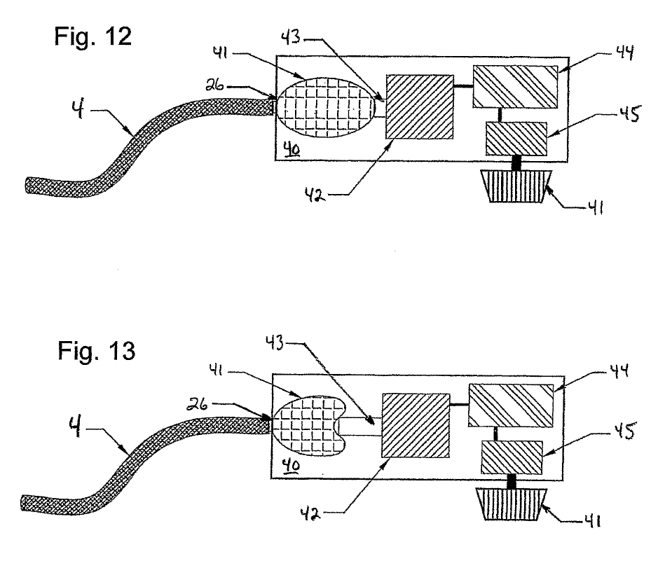

One such embodiment for electronic control of the mirror assembly 2 is shown in FIGS. 12 and 13. FIG. 12 illustrates the control device 40 in a non-activated position. FIG. 13 illustrates the control device 40 in the activated position.

The control device 40 includes a pressure bulb 41 and a connecting tube 4 connected to the pressure bulb 41. A solenoid 42 is positioned adjacent to the pressure bulb 41 and has a plunger 43 in contact with the pressure bulb 41. The solenoid 42 is electrically coupled with and receives operating signals from an electronic current control circuit 44. A potentiometer 45 is electrically coupled with and supplies operating signals to the electronic current control circuit 44.

Controlled energizing of the solenoid 42 causes the solenoid plunger 43 to compress the pressure bulb 41, creating a pressure for inflating the flexible tubing 18 in the mirror assembly 2 via the connecting tube 4. The force exerted by the plunger 43 is a function of the electric current flowing through the coil of the solenoid 42. The current supplied to the solenoid 42 by the electronic current control circuit 44 is proportional to the rotational position, and as a result, the resistance value of the potentiometer 45.

The electronic current control circuit 44 is preferably implemented using a voltage regulating integrated circuit which is configured to operate as a current regulating source. The electronic current control circuit 44 can, if desired, provide the additional function of generating a greater current value, yielding a relatively large solenoid plunger force, at the initiation of a dimming operation, before returning to a lower, nominal current value. Overall, the amount of force applied by the plunger 43 will be proportional to the selected position of the potentiometer 45. The additional function is accomplished by adding circuit components, such as a resistor coupled with a capacitor, for creating a turn-on time constant in the voltage regulating integrated circuit. The purpose of this additional function is to reduce the time required to achieve a selected dimming value when the mirror assembly 2 is first actuated.

As alternatives, a bellows can be substituted for the pressure bulb 41 of the electronic control device 40 shown in FIGS. 12 and 13. If desired, the solenoid 42 can be replaced with an electric motor. In such case, an appropriate electronic circuit would be employed for regulating the position of the shaft of the electric motor responsive to selective rotation of the potentiometer 45.

The previously described, dimmable mirror assembly 1 could also be applied to interior automotive mirrors. The controls for an interior mirror would be integrated into the housing of the mirror assembly. As an example, the lever which is typically provided for the operator of the vehicle to control the state of a conventional mirror could operate to press against a pressure bulb or a bellows to activate the mirror assembly 2 as previously described to achieve the desired level of dimming.

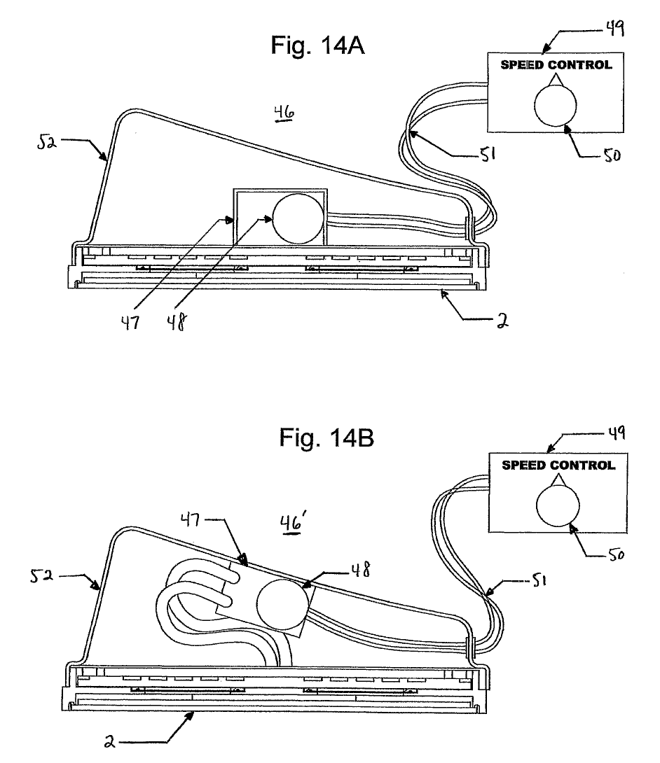

The foregoing describes dimming functions which are capable of being operated by direct manual control and electronic control mechanisms which are not contained within the mirror assembly 2. It is also possible, if desired, to provide mechanisms for controlling operations of the dimmable mirror assembly 1 having components which are contained within the mirror assembly 2 or within a metal or plastic shell 52 (see FIGS. 14A and 14B) which receives the mirror assembly 2. Components of the control mechanism can also be located in various other places including the interior of the vehicle, under the hood of the vehicle, or in a fender well of the vehicle.

In practice, alternative locations for the control mechanism can lead to counterbalancing considerations. For example, the additional weight and/or size of a mirror assembly 2 which is positioned on the outside of a vehicle, resulting from the configuration of the mirror assembly 2 and/or a shell which surrounds the mirror assembly 2, can make the overall mirror assembly 2 more susceptible to vibration. Counterbalancing this is that running wires to the outside of the vehicle to communicate with such a mirror assembly 2 can, in practice, be more convenient than running the connecting tube 4 to the mirror assembly 2, as previously described, particularly in cases where the mirror assembly 2 is located at a relatively large distance from the control mechanism.

The previously described mechanisms for direct manual control of the mirror assembly 2 are located inside the vehicle, separate from the mirror assembly 2. Interior placement of the control mechanism is presently considered preferred to conveniently permit direct manual control of the dimmable mirror assembly 1 by an operator from inside the vehicle. However, other placements of mechanisms for the direct manual control of the mirror assembly 2 are also possible.

For example, as an alternative for interior mirror applications, a mechanism for direct manual control of the mirror assembly 2 can be integrated into the mirror assembly 2, or into the shell which surrounds the mirror assembly 2. This can be advantageous in reducing the complexity of the resulting installation.

As an alternative for outside mirror applications, a mechanism for the direct manual control of the mirror assembly 2 can similarly be integrated into the mirror assembly 2, or into the shell which surrounds the mirror assembly 2. However, such placements are presently considered less preferred because this would then require the operator of the vehicle to reach outside the vehicle to control the dimmable mirror assembly 1.

The previously described mechanisms for electronic control of the mirror assembly 2 are remote from the mirror assembly 2. Such remote placement is preferred in order to minimize the size and weight of the mirror assembly 2 when mounted in a suitable mirror shell. As an alternative, portions of an electronic control mechanism for the mirror assembly 2 can be located within the mirror assembly 2, or within the shell for the mirror assembly 2, if desired. In practice, any portions of the electronic control mechanism which are located within the mirror assembly 2 and/or the shell for the mirror assembly 2 should be selected to reduce the overall size and weight of the mirror assembly 2 to the extent possible.

FIGS. 14A and 14B illustrate two examples of electronic control devices 46, 46′ having portions which are integrated into the mirror assembly 2. Each of the control devices 46, 46′ includes a miniature electric motor 47 coupled with an air pump 48. Responsive to a motor speed control 49, the motor 47 drives the air pump 48 to develop pressures for operating the mirror assembly 2 as previously described.

The motor 47 and the air pump 48 can be implemented as separate components, or as a combined assembly to further minimize the size and weight of the electronic control mechanism and the mirror assembly 2 with which it is used. An example of a combined motor and pump assembly which can be used to develop such a function is the “CTS Series” single head micro-diaphragm pump and compressor which is manufactured by Hargraves Technology Corporation of N.C. The use of electronically controllable components having a minimum size and weight is preferred to reduce the susceptibility of the mirror assembly 2 to vibration.

The motor speed control 49 can be implemented using an appropriate electronic circuit for regulating the speed of the motor 47 responsive to the selective rotation of a potentiometer 50. Wires 51 connect the motor speed control 49 with the motor 47 and pump 48 which are located within the mirror assembly 2, or a shell for containing the mirror assembly 2, simplifying the connection between the mirror assembly 2 and the motor speed control 49 which is typically located within the vehicle.

Responsive to signals received from the motor speed control 49, via wires 51, the pressure developed by the pump 48 will be proportional to the speed of the motor 47. The amount of dimming of the mirror assembly 2 will be correspondingly proportional to the speed of the motor 47, with maximum dimming being achieved at full motor speed. The maximum pressure achieved at full motor speed is preferably limited to avoid overpressure and the potential for damage to the mirror assembly 2. Control of the maximum pressure which is developed can also be achieved by proper selection of the motor and pump which are used, or by providing an air bleed hole in the pressure line (for example, in the flexible tubing 18).

The previously described, miniaturized motor and pump combination could also be used inside the vehicle, if desired, as an alternative to the bulb 36 or the bellows 38. However, in such case, a certain amount of noise resulting from operations of the motor within the vehicle would be detectable.

Many external vehicle mirrors are convex in shape. For example, convex mirrors are often employed to provide wide angle views to an operator of a vehicle, primarily for right side view mirrors. Convex side mirrors are also required for most European commercial vehicles. The previously described dimmable mirror assembly 1, which is shown in conjunction with plates 6, 13 having flat surfaces, can also be applied to convex mirrors without encountering the otherwise typical difficulties of manufacturing laminated curved glass substrates.

In such a configuration, the face plate 6 and the mirrored plate 13 of the mirror assembly 2 would be manufactured in convex, dimensionally matched pairs. Glass plates can be manufactured in this way using a sag molding technique. For this, flat glass is placed on a curved mold and heated until it sags to match the mold shape. Molds having matching inner and outer diameters are used to create dimensionally matched pairs of glass plates, which would then serve as the face plate 6 and the mirrored plate 13. The housing section 5 and the backing plate 16 would then be appropriately modified to match the curved face plate 6 and the curved mirrored plate 13. Plastic plates could similarly be manufactured in convex, dimensionally matched pairs, in standard injection molds, to develop the face plate 6 and the mirrored plate 13 of the mirror assembly 2.

It is to be understood that while the foregoing structures are presently considered to be preferred, variations in such structures are also clearly possible.

In particular, while various parameters and ranges of parameters have been indicated for some of the components which have been described, these parameters are presently considered preferred, but can be varied to suite a particular application, as desired. For example, for a mirror assembly 2 having a face plate 6 or a mirrored plate 13 which is particularly large, or small, it is expected that the parameters which will be useful for such applications will lie outside of the ranges which have been specified.

Other variations will also occur to the skilled artisan. For example, the foregoing has been described in the context of developing pressures for moving the plates 6, 13 relative to each other. However, similar functionality can be achieved by using a vacuum in place of a pressurized element. Similarly, while the foregoing description positions flexible tubing 18 between structural components including the frame 10 and the backing plate 16, which is presently considered preferred for purposes of robustness, other arrangements would also be possible. For example, flexible tubing 18 could be positioned directly between the face plate 6 and the mirrored plate 13, or other intervening structures could be employed, if desired.

It will therefore be understood that various changes in the details, materials and arrangement of parts which have been herein described and illustrated in order to explain the nature of this invention may be made by those skilled in the art within the principle and scope of the invention as expressed in the following claims.

What is claimed is:

1. A dimmable mirror assembly comprising:
a first, light-transmitting plate, and a flexible sealing member, wherein the first plate and the flexible sealing member are operatively coupled to define a central cavity;
a second, light-reflecting plate coupled with the flexible sealing member and contained within the central cavity;
a light-absorbing optical fluid contained within the central cavity, and between the first plate and the second plate; and
an expandable element operatively coupled with the first plate and the second plate and separating the first plate and the second plate, for moving the second plate relative to the first plate and between a non-activated position in which the second plate is adjacent to the first plate and an activated position in which the second plate is spaced from the first plate, wherein the optical fluid fills a gap developed between the first plate and the second plate.

2. The assembly of claim 1 which further includes a frame having portions which receive the first plate and opposing portions which receive the flexible sealing member.

3. The assembly of claim 2 wherein the flexible sealing member includes at least one flexible panel coupled with an aperture in the frame, for maintaining a substantially constant volume of the optical fluid within the central cavity.

4. The assembly of claim 2 which further includes a backing plate coupled with the flexible sealing member and the second plate, wherein the backing plate is movable relative to the frame and the first plate received by the frame.

5. The assembly of claim 4 wherein the expandable element is positioned between the frame and the backing plate.

6. The assembly of claim 5 which further includes an outer housing coupled with the frame, and a spring positioned between the outer housing and the backing plate for biasing the second plate coupled with the backing plate toward the first plate.

7. The assembly of claim 6 wherein the spring is a spring washer.

8. The assembly of claim 6 wherein the spring is a section of flexible tubing.

9. The assembly of claim 6 wherein the spring is a leaf spring.

10. The assembly of claim 6 wherein the frame incorporates a spring for biasing the second plate coupled with the backing plate toward the first plate.

11. The assembly of claim 4 wherein the expandable element is flexible tubing positioned between the frame and the backing plate.

12. The assembly of claim 11 which further includes a channel developed between the frame and the backing plate, for receiving the flexible tubing.

13. The assembly of claim 12 wherein the channel is substantially oval-shaped.

14. The assembly of claim 12 wherein the channel is substantially U-shaped in cross-section and incorporates a notched projection extending into central portions of the channel.

15. The assembly of claim 11 which further includes a plurality of guides for receiving the flexible tubing between the frame and the backing plate.

16. The assembly of claim 1 wherein the expandable element is flexible tubing.

17. The assembly of claim 16 wherein the flexible tubing is continuous, and wherein the flexible tubing is coupled with peripheral portions of the first plate and the second plate.

18. The assembly of claim 16 wherein the flexible tubing is formed in sections, and wherein the sections of the flexible tubing are coupled with peripheral portions of the first plate and the second plate.

19. The assembly of claim 18 wherein the sections of the flexible tubing are coupled with opposing edges of the first plate and the second plate.

20. The assembly of claim 1 wherein the first plate is formed of a light-transmitting material selected from the group of light-transmitting materials consisting of glass and plastic.

21. The assembly of claim 1 wherein the second plate is formed of a material selected from the group of materials consisting of glass, plastic and metal, and wherein the selected material has a mirrored surface.

22. The assembly of claim 1 wherein the optical fluid is a substantially transparent host fluid, and a light absorbing dye dissolved into the host fluid.

23. The assembly of claim 22 wherein the host fluid is a silicone oil.

24. The assembly of claim 23 wherein the silicone oil is siloxane.

25. The assembly of claim 22 wherein the host fluid is a phthalate ester.

26. The assembly of claim 22 wherein the light absorbing dye is selected from the group of dyes consisting of aniline dyes, azo dyes and anthraquinone dyes that are soluble in oil.

27. The assembly of claim 22 wherein the first plate has an outer surface, and wherein the outer surface of the first plate has an anti-reflective coating.

28. The assembly of claim 1 which further includes an actuator coupled with the expandable element.

29. The assembly of claim 28 wherein the actuator is a pressure-producing device.

30. The assembly of claim 29 wherein the pressure-producing device is pneumatically operated.

31. The assembly of claim 29 wherein the pressure-producing device is hydraulically operated.

32. The assembly of claim 29 wherein the pressure-producing device is a compressible bulb.

33. The assembly of claim 29 wherein the pressure-producing device is a bellows.

34. The assembly of claim 29 wherein the pressure-producing device is an air pump operated by a motor.

35. The assembly of claim 29 wherein the pressure-producing device is remotely coupled with the mirror assembly.

36. The assembly of claim 29 wherein the pressure-producing device is directly coupled with the mirror assembly.

37. The assembly of claim 29 which further includes a control unit coupled with the pressure-producing device.

38. The assembly of claim 37 wherein the control unit includes a cam having a camming surface engaging the pressure-producing device, and a knob coupled with the cam by a connecting shaft, for rotating the cam responsive to rotations of the knob.

39. The assembly of claim 38 which further includes a detent mechanism coupled with the connecting shaft, for retaining the cam and the knob in a selected position.

40. The assembly of claim 37 wherein the control unit includes a solenoid having a plunger engaging the pressure-producing device, a control circuit coupled with the solenoid for regulating extension of the plunger, and a variable resistive element for regulating the control circuit.

41. The assembly of claim 40 which further includes a knob coupled with the resistive element, for selecting a position for the resistive element.

42. The assembly of claim 37 wherein the control unit includes a motor coupled with the pressure-producing device, a control circuit coupled with the motor for regulating positioning of the motor, and a variable resistive element for regulating the control circuit.

43. The assembly of claim 42 which further includes a knob coupled with the resistive element, for selecting a position for the resistive element.

44. The assembly of claim 37 wherein the control unit includes a motor coupled with the pressure-producing device, a control circuit coupled with the motor for regulating speed of the motor, and a variable resistive element for regulating the control circuit.

45. The assembly of claim 44 which further includes a knob coupled with the resistive element, for selecting a position for the resistive element.

46. The assembly of claim 1 which further includes a spacer between the first plate and the second plate.

47. The assembly of claim 46 wherein the spacer is a plurality of dots formed on an opposing surface of at least one of the first plate and the second plate.

48. The assembly of claim 1 wherein the first plate and the second plate are paired flat plates.

49. The assembly of claim 1 wherein the first plate and the second plate are paired convex plates.
